(19) United States
(12) Patent Application Publication
(10) Pub. No.: US 2011/0238439 A1
(43) Pub. Date: Sep. 29, 2011

(54) METHOD AND SYSTEM FOR IDENTIFYING VOLATILITY IN MEDICAL DATA

(76) Inventor: William H. Rice, Austin, TX (US)

(21) Appl. No.: 13/072,627

(22) Filed: Mar. 25, 2011

Related U.S. Application Data
(60) Provisional application No. 61/317,585, filed on Mar. 25, 2010.

(51) Int. Cl. G06Q 50/00; G06Q 10/00

(52) U.S. Cl. 705/2

(57) ABSTRACT

A system and method for evaluating the effectiveness of a medical treatment and predicting future medical issues is provided. A digital set of biometric data comprising a plurality of biometric data points is received and stored in a digital database. The digital set of biometric data is analyzed to determine its relative volatility. The relative volatility is then evaluated to help determine the effectiveness of a medical treatment and predict future medical issues.

### RELATED APPLICATIONS

This application claims the benefit of U.S. Provisional Application 61/317,585 filed on Mar. 25, 2010, which is hereby incorporated by reference.

### FIELD OF THE INVENTION

The disclosed subject matter relates primarily to systems and methods for identifying volatility in medical data.

### BACKGROUND OF THE INVENTION

Generally, medical data is analyzed as absolute numbers. A particular data point (e.g. a biometric measurement) is either within or without a preset minimum or maximum level. Medical professionals use this information to assist in evaluating the most appropriate treatment method. For example, a medical professional may order a cholesterol test to identify the level of cholesterol in the patient. These levels are compared against minimum and maximum levels to assist the medical professional in evaluating whether the patient has a cholesterol problem. Furthermore, how far outside the “normal range” the patient's cholesterol is, helps the medical professional choose a proper treatment—only a minor deviation out of the range may require only a change in diet; however, a major deviation may require diet, exercise, and medication.

Another method of assisting medical professionals in evaluating a proper treatment course for a patient is disclosed in U.S. Pat. No. 6,955,647 “SYSTEM AND METHOD FOR REPETITIVE INTERVAL CLINICAL EVALUATIONS” issued on Oct. 18, 2005 to William H. Rice (hereinafter the “Rice Patent”), and which is hereby incorporated by reference its entirety and made part of the present U.S. Utility Application for all purposes. The Rice Patent discloses a statistical analysis tool that continually reevaluates a control range for a particular patient and alerts the patient when a data point is outside the control range. The patient's data points are entered and a new control range is created based on all the data entered thus far. As new data is entered, the control range is reevaluated to account for the newest data. When a data point is entered that falls outside the control range, an alert is generated. Rather than the relatively static range that is derived from many data points from many different people as discussed above, the Rice Patent discloses a dynamic range that is derived from a particular patient's data points.

More than 90 million Americans live with chronic diseases. Care for these Americans accounts for more than 60% of the nation's medical care costs. By definition, a chronic disease progresses over time with a generally predictable set of costly exacerbations, complications and recurrences.

A central precept to the discussions on health care costs is that there is a cost-quality function from which one may derive a linear cost-quality curve. On such a cost quality curve, so the argument goes, any reduction in the planned budgetary growth of health care dollars will result in lower-quality health care. To the contrary, however, the actual cost-quality curve for health care has been shown to be significantly non-linear. FIGS. 1A and 1B depict the perceived and actual cost-quality curves showing the relationship between cost and health care quality. FIG. 1A depicts an expected cost-quality curve 10, while FIG. 1B depicts the actual non-linear cost-quality curve 12.

In the actual health care cost-quality curve 12 of FIG. 1B, increased costs do not always correlate to improved quality. Instead, there has been shown to be a “quality valley” 14, where health care quality actually decreases with increased expenditures for health care. Understanding this potential “quality valley” 14 is essential to the creation of real improvements and cost savings in health care. That is, if “quality valley” 14 could be either carefully managed against for either its elimination or, if it cannot be eliminated, its avoidance, there could be an opportunity simultaneously decrease costs and improve quality.

Research for two common medical diagnoses, congestive heart failure (CHF) and pneumonia, for example, indicates wide variation in outcomes among providers. By matching severity-adjusted mortality data to hospital-specific charge data, one can observe that higher average charges often associate with a lower quality of care.

These results support the conclusion that significant 5 variations in charges exists among hospitals. These variances may imply that higher costs associate with lower quality (resulting, for example, in higher severity-adjusted mortality rates). This represents unnecessary resource utilization.

Making comparisons among the ten countries having the highest Gross Domestic Product (GDP) per capita further validates this conclusion. Data from the United States Statistical Abstract indicates that the United States spends the largest percentage of its gross domestic product (GDP) on health care, while exhibiting one of the world's lowest life expectancy at birth (LEAB rates). International health expenditure studies are difficult to conduct, however, because of factors such as data quality, variable accounting methods, and significant social-cultural differences. Despite these shortcomings, a highly reasonable conclusion remains that, with the present systems and methods for managing diseases such as CHF and pneumonia, spending more dollars on health care results in a decrease in health care quality received, as measured on a large scale, for example, by LEAB rates.

Although every physician should consider the best interests of his/her patients, the medical system has evolved with a history of incentives, threats (e.g., medical malpractice), and customs that can significantly increase costs, while not improving quality.

Additionally, disease intervention processes and treatments, all too frequently seek to improve patient comfort, longevity, and physical functioning. These processes and treatments employ surrogate endpoints based on logical, but unproven, extensions of an existing, but incomplete, disease process model. A great number of physician actions are based on these surrogate endpoints. These surrogate endpoints, however, often lead to increased costs and examinations without improved results.

A need exists, therefore, for significant efforts to optimize the cost and quality relationship of healthcare. Prior efforts focus on the development of “best practices” protocols, medical error reduction, bulk purchasing and pharmaceutical benefits management, new medicine, minimally invasive surgery and the redesign of care systems. These efforts seek to more effectively manage demand for health services. While past practices are important, these efforts fail to address any way to reduce costs and improve quality in healthcare. In particular, they already fail to provide for complication identification and proactive symptom treatment of chronic disease exacerbation in the individual patient.

One avenue of attempting to better practice early complication identification and proactive symptom treatment has been through the use of computers. Such attempts to use computers, for example, may center on communicating automatically with a patient regarding a previously diagnosed disease. In such processes, automatic therapy adjustment becomes responsive to information received from the patient. Such automated schemes of medical treatment typically involve the use of computers and the Internet to treat patients remotely. The purpose of these conventional schemes of remote treatment by using computers or Internet avoids unnecessary office visits, thereby effecting savings in overall healthcare costs. Thereby, a physician may be virtually “present” at the patient's location and help treat the patients remotely.

Unfortunately, attempts to automate patient-physician communications do not change previous paradigms for certain chronic diseases. With many of these chronic diseases, infrequent physician visits, either in person or through a virtual office, are accepted as normal. Thus, it has not been possible to identify evolving complications, exacerbations or recurrences, within certain classes of chronic disease patients. At the same time, early interventions may mitigate a patient's worsening clinical condition. In fact, in many instances, early interventions may avoid the need for emergency medical services altogether. Also, disease predictive models have not proven effective to predict the worsening of a patient's condition from chronic diseases. Because of these and other reasons, a standardized therapy based upon broad demographic models is difficult or impossible to employ remotely.

A need exists, therefore, for a system and method that allow early detection of chronic disease exacerbations or complications in order to decrease the need for emergency medical services while measurably improving patient outcomes.

Returning to the above discussion regarding the health care cost-quality curve, often chronic diseases, such as CHF, exhibit a non-linear cost-quality relationship. Accordingly, managing a patient's condition preventively, as opposed to remedically, may assist in avoiding a “quality valley.” That is, such preventive management could avoid the situation of increased health care expenditures, ironically, resulting in lower returns in patient outcome. If it were possible to achieve early detection of chronic disease exacerbations or complications, well before the greater cost treatments are necessary, then the health care industry could avoid troubling regions of a non-linear cost-quality curve. In a larger sense, therefore, there is a need for an early detection method and system making it possible to greatly reduce overall health care costs while improving patient quality of life.

### BRIEF SUMMARY OF THE INVENTION

There is a need for a method and/or system for analyzing data points to evaluate the relative volatility contained in the data set and alerting when an anomaly is identified. By analyzing the volatility a medical professional may be able to better diagnose, treat, and evaluate a particular patient.

One aspect of the disclosed subject matter involves receiving a set of data points and performing statistical analysis on the data points to identify the relative volatility contained in the set of data points.

An additional aspect of the disclosed subject matter is to provide an alert when potentially anomalous volatility is detected within the set of data points.

These and other aspects of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features and advantages here provided will become apparent to one with skill in the art upon examination of the following FIGUREs and detailed description. It is intended that all such additional systems, methods, features and advantages that are included within this description, be within the scope of the claims to be filed with any regular utility patent application claiming priority based on this provisional filing.

### BRIEF DESCRIPTIONS OF THE DRAWINGS

The features, nature, and advantages of the disclosed subject matter will become more apparent from the detailed description set forth below when taken in conjunction with the accompanying drawings, wherein:

FIGS. 1A and 1B illustrate perceived linear and actual non-linear relationship between health care costs and quality of care;

FIG. 2 is a flow chart depicting one embodiment of the disclosed method;

FIG. 3 is a flow diagram illustrating one embodiment of a process performed by the disclosed system;

FIG. 4 shows a set-up process which a patient may employ in using an embodiment of the disclosed subject matter;

FIGS. 5-8 and 9A-B present exemplary screen shots of the steps performed by the health parameter statistical control measurement tool according to an embodiment of the disclosed subject matter;

FIG. 10 depicts an exemplary screen shot of a “Report” according to an embodiment of the disclosed subject matter;

FIG. 11 portrays an exemplary screen shot of an additional alerting step according to an embodiment of the disclosed subject matter;

FIG. 12 shows an exemplary screenshot of an “EXIT” step according to an embodiment of the disclosed subject matter;

FIGS. 13A-B show one view of a computer spreadsheet having embedded formulae which an embodiment of the disclosed subject matter may use to record, manipulate, and present information to an interface such as those of FIGS. 5 through 12;

FIG. 14 illustrates a typical computer system for employing the many aspects of the disclosed subject matter;

FIG. 15 is a table of three sets of exemplary data points;

FIG. 16 is a graph of the three sets of data points of FIG. 15;

FIG. 17 is a table of three additional sets of exemplary data points;

FIG. 18 is a graph of the three additional sets of data points of FIG. 17; and

FIGS. 19A-C show a view of a computer spreadsheet having embedded formulae which an embodiment of the present disclosure may use to record, manipulate, and present information to an interface.

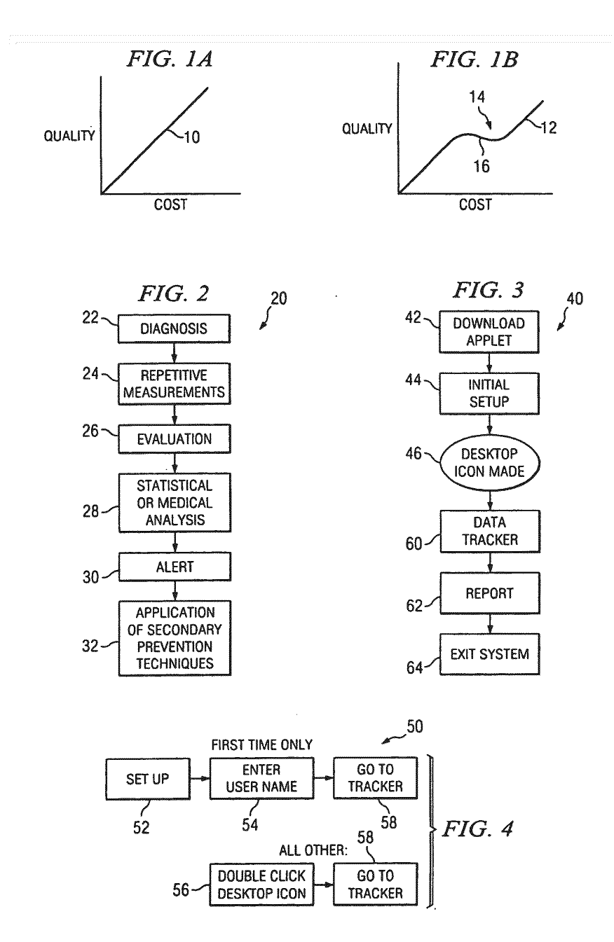

### DETAILED DESCRIPTION OF ILLUSTRATIVE EMBODIMENTS

Although described with reference to the medical profession and biometric data, one skilled in the art could apply the principles discussed herein to any area where the volatility of a set of data points could provide relevant information.

Traditional models for the evaluation of biometric data have relied on the idea that an increasing or decreasing value, as compared to previous baselines (or reference ranges, i.e. normal ranges), may be of clinical relevance. An innovative method to find relevance in biometric data disclosed herein is to examine the volatility within a set of biometric data thereby providing early warning when a new data point increases or decreases the baseline volatility. The volatility between two data sets could be very different although the data sets both remain within a prescribed range. Similarly, the volatility of two data sets could be very different although the data sets have the same mean, median, and/or mode. Therefore, it is of interest to medical professionals to evaluate the volatility of data sets in addition to more traditional comparisons.

In mechanical engineering, one may use a microphone and record the sound of a jet engine known to be in good repair. Thereafter, comparing the recordings of other jet engines to the original recording can provide a very efficient technique to identify engines whose function may be, or will become, aberrant. While the precise understanding of why a jet engine's sound is different may not be known at the time of recording, the recording nonetheless can serve as a tool to provide an early warning of pending malfunction because some level of volatility in the dynamical balance of the engine parts and functions falls out of balance and is expressed acoustically. In the same way, in complex biological systems, the changing volatility of a data series of physiological parameters can be an important indicator of an approaching imbalance that is manifested in health care as a change in a patient's condition.

Generally, volatility is a measure of the state of instability of a particular set of data points. The less volatile a particular set of data points is, the higher the chance a particular data point will be close to the other data points in a set (the converse is also true). This volatility measurement can assist medical professionals in better evaluating the effectiveness of a treatment and/or in better predictions of potential future problems.

For example, in the treatment of asthma, medical professionals often use a “peak flow” measurement to evaluate how effective a person can move air out of their lungs. As with any data set, when peak flow measurements are gathered over time, the measurements show some level of volatility. By tracking this volatility, any new data point that causes an increase in volatility (when compared with previous data points) represents an important clinical change.

The issue of cost as it relates to the level of healthy care received can be thought of in terms of quality. Quality has been defined as the level of results with respect to the overall cost. The quality goal of this project is to maintain patient health for the longest time for the least cost. Statistics can be used to determine the optimal use of resources at the needed time to maintain a high level of quality care without the patient having to come to a medical setting. Use of these statistical methods can make increase the patient's quality of care when applied to remote medicine.

While statistics cannot be used to give a definitive answer of what will cause an individual to experience a loss of quality, it can be used to give guidance. Through use of multiple measurements over a period of time, a pattern can be established. The information collected can be used in concert with statistical methods to determine if a patient's overall health is getting better or worse. These methods can be any statistical method known to those skilled in the art, such as the Deming method or any of the methods of quality control.

The most effective way to treat the most people with the highest level of care is to optimize resources. One way to optimize the limited resources is in the area of preventative care, treatment monitoring, and early problem detection. Monitoring of a patients condition i.e. metrics and the timely entering of the data can be utilized to assist in the preventive care arena by addressing problems before they become unmanageable.

Preventative care of course has quality spectrum. At the upper end of this spectrum is the Deming statistical method, wherein the most good is done with respect to the available resources. This uses statistically placed care to keep a person from getting sick or their condition getting worse. A little further down on the spectrum there might be a system where the patient is allowed to deteriorate to a point where preventative care is still available, but the patient's health has still decreased and it cost more to recover. The bottom end of the spectrum is no preventative care and everything is treated only when it becomes debilitating. The goal is to use the Deming method to make the most good of available resources, keep cost low, and people healthy.

The present disclosure may use a nonlinear model, such as a chaotic model. However, various non-linear models may be envisaged. In chaotic models, a sensitive dependence exists on model initial conditions and assumptions. Mathematically, the initial conditions of a system, when varied by an exceedingly small amount, can result in widely variable outcomes without a distinguishable pattern.

In a chaotic or complex system, repetitive measurements improve the ability to model and predict future conditions. Weather prediction provides a classic example of non-linear systems with “chaotic” or “complex” components. The National Oceanographic and Atmospheric Association (NOAA), a component of the U.S. Department of Commerce gathers data and predicts the weather. Several decades ago, as mainframe computers became available to solve large data set problems, programs to model weather systems began to evolve from improving NOAA's weather predicting ability. Soon, NOAA discovered that if the input data of the program varied by some exceedingly small amount (e.g., if barometric pressure at some location increased by an un-measurable thousandth of an inch), then the model output differed drastically.

Optimizing a non-linear system with a “chaotic” component employs repetitive data sampling where the critical element is the periodicity of the data sampling. The best possible weather predictions, for example, depend on frequent measurements over time. More intensive measurements taken less frequently are not a reliable approach for optimizing weather prediction.

Now, a repetitive data sampling system has direct applications to healthcare. For example, one embodiment of the disclosed subject matter may be used to identify problems associated with the care of a patient diagnosed with congestive heart failure (CHF). CHF is characterized by a heart muscle that cannot pump blood effectively. Patients with CHF generally have difficulty breathing because excess fluids “behind a weakened heart accumulate in the lungs. Care for CHF patients includes medicines such as diuretics to improve breathing by removing excess fluids. With the removal of excess fluids, the patient's lungs become “clear,” which allows the patient to breathe more normally.

Because water is the primary component of the human body, body weight measurements (on an ongoing basis) are an excellent indicator of the clinical status of a patient with CHF. Current care of most CHF patients includes visits to physicians' offices approximately every 3 to 6 months, depending on the severity of symptoms. By monitoring body weight twice a week, hospitalization rate and corresponding costs can be reduced by approximately 50-90%. Thus, cost has been reduced and quality of life has improved. Repetitive clinical monitoring of body weight, for example, twice a week, in CHF patients should be the “standard of care.”

Just as weather prediction may be viewed as a chaotic system, so too may prediction of emergency conditions with chronic diseases be considered a chaotic system problem. It should be noted here, however, that the disclosed subject matter is not limited to applications in CHF, but may have use in applications to other chronic diseases such as, but not limited to, diabetes, asthma, emphysema, cancer, and other cardiovascular diseases known to those skilled in the art.

Nonetheless, CHF provides an excellent case for applying the teachings disclosed, since CHF patients represent the largest disease class and the most commonly hospitalized group of individuals over the age of in the United States. Just as two weather conditions may, in almost all salient aspects, appear virtually identical, two CHF patients may appear much the same on one day, but exhibit drastically different conditions in only a very short span of time. In one example, two CHF patients could “look” clinically identical in two discrete observations having the exact same medical histories, lifestyle, and clinical findings and can be seen, diagnosed and treated at the exact same time in the exact same way. However, these discrete observations lack any historical trends. One cannot accurately predict which patient will progress with an uneventful clinical course and which patient will deteriorate and need intensive care without additional data.

This example of two “identical” patients may be considered as analogous to the weather system model in that the two “identical” weather conditions exhibiting two seemingly identical initial conditions (differing barometric pressure by an un-measurable thousandth of an inch). Only repetitive monitoring will cause historical trends to distinguish between patients in many instances.

Interestingly, an individual's body weight provides an easily measured parameter that enables prediction of likely exacerbations and complications in CHF patients. CHF patients have occasional exacerbations that require hospitalization and intensive care. However, a predictable sequence of symptoms and findings precedes the patient's “decomposition.” CHF patients often begin a pattern of weight gain. This progression of an easily measured parameter provides a window of opportunity for emergency condition prevention in CHF patients. Mitigation of disease exacerbations consists primarily of alerting the patient, and eventually, the healthcare provider team of the weight gain trend. When the healthcare team knows that a CHF patient is gaining weight, the treatment can be changed. For example, incremental doses of diuretics, changes in diet and other measures can very effectively prevent the acute clinical exacerbation.

Thus, in chronic disease care, more frequent data inputs can result in earliest detection of clinical exacerbations and complications. In this instance, secondary prevention can address an evolving problem before the problem incapacitates the patient and requires intensive, expensive, and, often times, less successful medical intervention.

One aspect of this disclosure includes a method and process to support the more frequent collection of relevant chronic disease data, which may avoid the need for such interventions. Referring to FIG. 2, there appears a flow chart depicts a repetitive, interval, clinical evaluation method 20 consistent with the teachings of this disclosure. In step 22, a patient may be diagnosed with a chronic disease or condition. This disease or chronic condition may have a specific set of disease-associated parameters that may be measured by the healthcare team in a clinical environment or the patient at home.

These parameters may be either objective measurements, such as the patient's weight, as discussed previously, or subjective measurements, as when dealing with other conditions such as mental disease. The patient or healthcare provider in step 24 measures the parameters. These measurements are then compiled by a computer program as part of the patient's historical record. The instant measurements are evaluated for potential data entry errors or indication of immediate healthcare problems in step 26. In step 28, the overall history of measurements is studied to identify statistical or medical indicators of worsening conditions or potential problems. The patient or healthcare team is then alerted at step 30 to potential future problems. This alert allows secondary prevention techniques to be applied to the patient's condition. This allows the disease condition to be treated in a proactive rather than reactive manner, such as through the application of secondary prevention techniques at step 32. Furthermore, this allows patient quality of life to increase while reducing healthcare costs. Furthermore, this approach, when taken on a macroscopic scale, can significantly decrease healthcare costs of an individual medical practice, a hospital system or geographical region.

FIG. 3 illustrates the flow of one embodiment of a process 40 that a computer may implement as part of the disclosed subject matter. In step 42, process 40 starts by downloading a program application, for example, a JAVA applet from a Web server. The JAVA applet may run on a patient's computer using a JAVA-compatible Web browser, such as Netscape Navigator or Microsoft Internet Explorer. It should be noted that if a second patient desires to also use the system, the program application may be written to accommodate additional patients or, alternatively, the second patient may download the JAVA applet another time, in order, for example, to keep the associated patient information separate.

In step 44, after the JAVA applet is downloaded, the patient initially sets up the system. In step 46, the 5 process creates a desktop icon. FIG. 4 illustrates an example of the set up process 50 according to an embodiment of the disclosed subject matter. So, referring to FIG. 4, in step 54, a first time patient inputs an identifying name. The process then continues to the health parameter 10 statistical control measurement tool. A repeat patient, in step 56, simply double clicks on a desktop icon to enter the program, and then the process goes, via step 58, to the health parameter statistical control measurement tool.

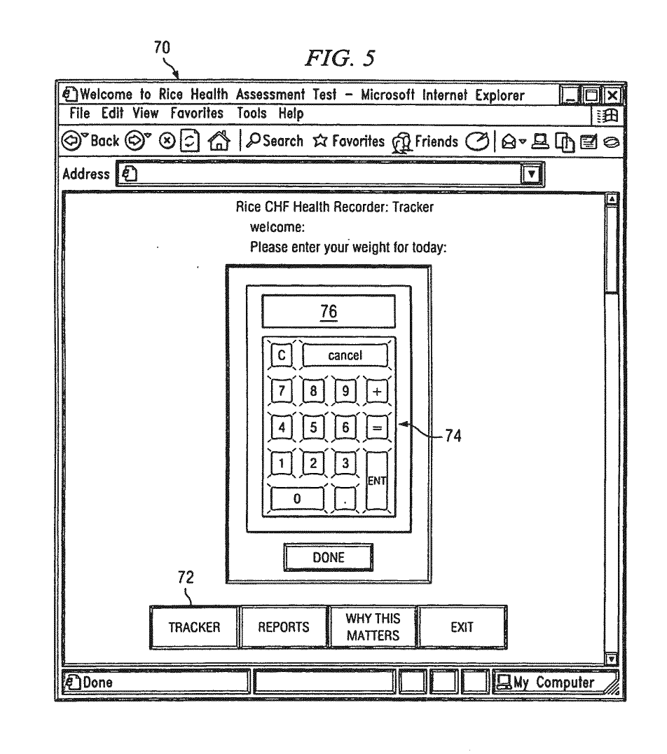

Referring back to FIG. 3, process 40 proceeds to the health parameter statistical control measurement tool at data tracker step 60. The health parameter statistical control measurement tool receives inputs or parameters associated with a particular patient's health condition or clinical status. The health parameter statistical control measurement tool will be described in more detail below with respect to FIGS. 5-9.

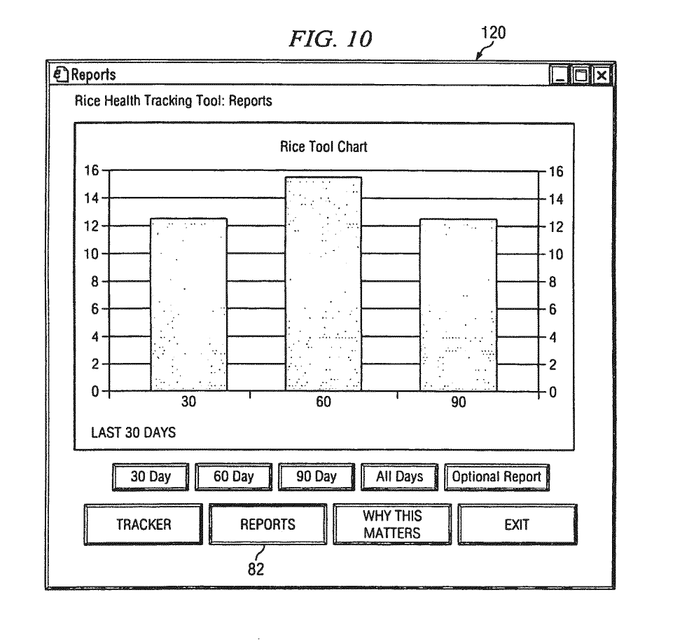

In step 62, process 40 generates a report, which may include a graph covering a desired time frame selected by the patient. In exit system step 64, the process reaches an endpoint. These steps will be explained in more detail below with respect to FIGS. 10-12.

FIGS. 5-9 present exemplary screen shots, such as screen shot 70 of FIG. 5, to illustrate the steps performed by the health parameter statistical control measurement tool of the disclosed subject matter. After a patient signs into the system, the system goes to health parameter statistical control measurement tool as indicated by the highlighted “TRACKER” button 72 of screen shot 70 of FIG. 5.

The system will be here described in conjunction with an application for a CHF patient, wherein the system tracks the parameter of a CHF patient's body weight as a way to prevent chronic disease condition exacerbations. Because many other chronic diseases have easily measured parameters highly associated with the patient IS clinical status, the system of this disclosure can be broadly applied to the care of these diseases as well. Chronic diseases in the United States that may be tracked include, but are not limited to: asthma, for which peak flow can be measured; chronic obstructive pulmonary disease (emphysema), for which flow can be measured; diabetes, for which glucose can be measured; other cardiovascular diseases such as arrhythmia, infarction, ischemia, arteriosclerosis for which number of nitroglycerin tablets taken daily, number of chest pain episodes, ambulation distance without pain, minutes walking without pain, etc. can be measured; rehabilitation, such as from hip and knee replacements, for which ambulation paces/activity can be measured; or cancer, post chemotherapy/post radiation of toxicity such as food/liquid intake, etc. can be measured.

Following a prompt from a computer supporting the disclosed process, a CHF patient or healthcare worker may enter the patient's measured body weight or other measured parameters. In the embodiment shown in FIG. 5, the patient clicks on number pad 74, which appears on screen 70 to enter the weight, which appears in display area 76.

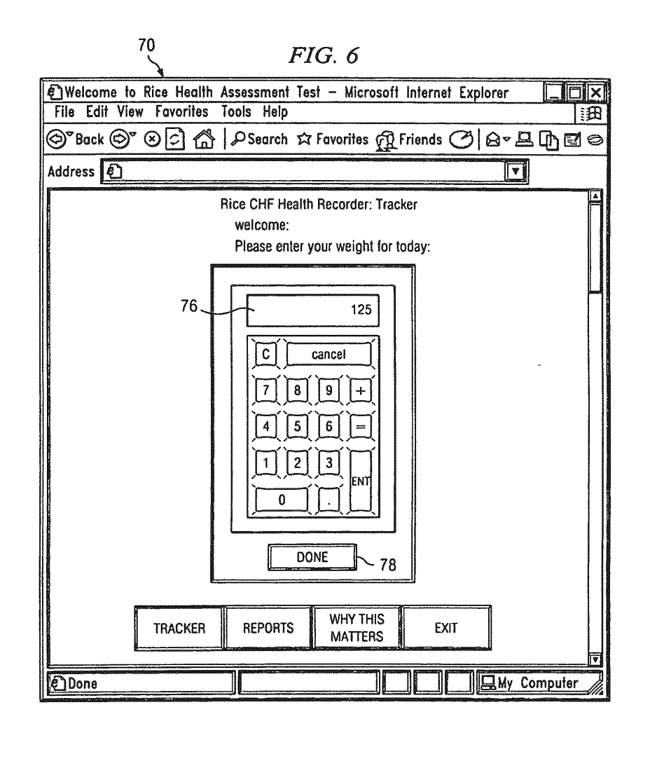

FIG. 6 illustrates an example in which the patient entered a weight of 125 in display area 76. Once the patient enters the weight, the button 78 labeled “Done” may be pressed to continue. It should be noted that in other embodiments, the patient might be asked to confirm the entry. Other methods of data entry, either manual or automated, as known to those skilled in the art, may be 5 used to facilitate the process.

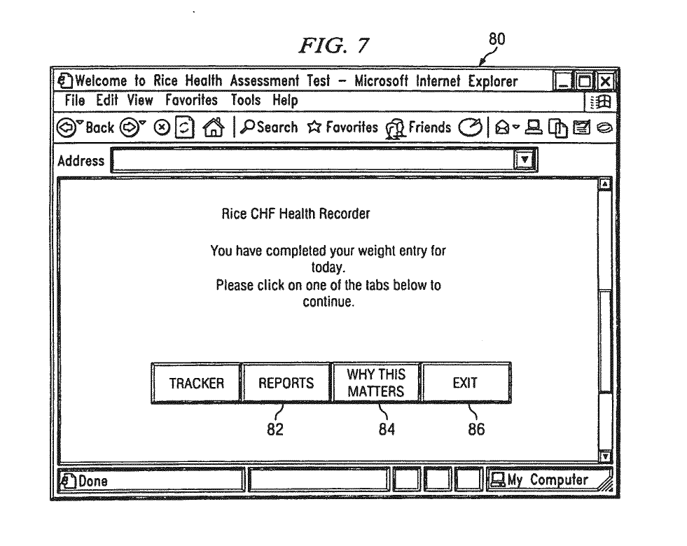

FIG. 7 provides the next exemplary screen shot 80 where the patient may confirm that he has completed the weight entry for the day. Next, the process prompts the patient to click on the appropriate tab to continue. As shown, the patient may have several options. For example, the patient may choose to receive a report by clicking on the “REPORTS” icon 82, information on “WHY THIS MATTERS” by clicking on icon 84, or exit the system by clicking on the “EXIT” icon 86.

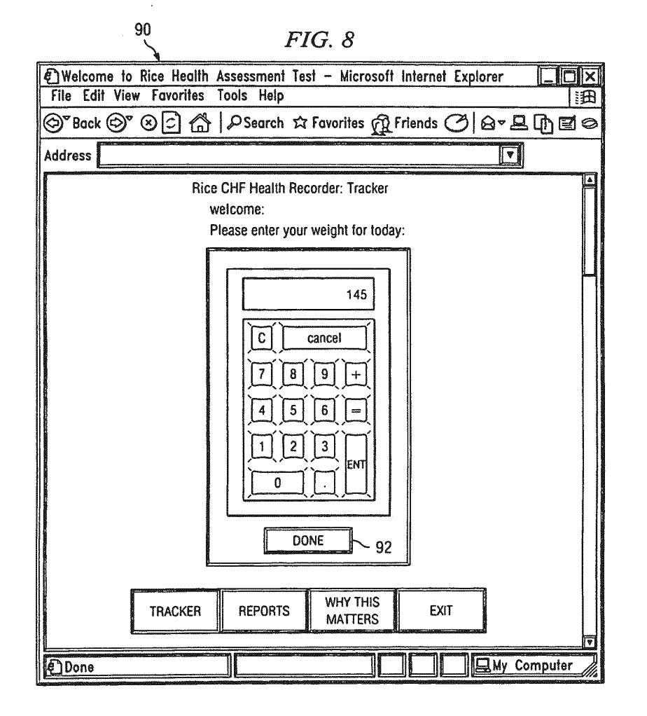

In FIG. 8, screen shot 90 indicates that the patient entered a weight of 145 the next time. Once the patient enters the weight, icon 92 labeled “Done” is clicked to continue. It should be noted that in other embodiments, the patient might be asked to confirm the entry.

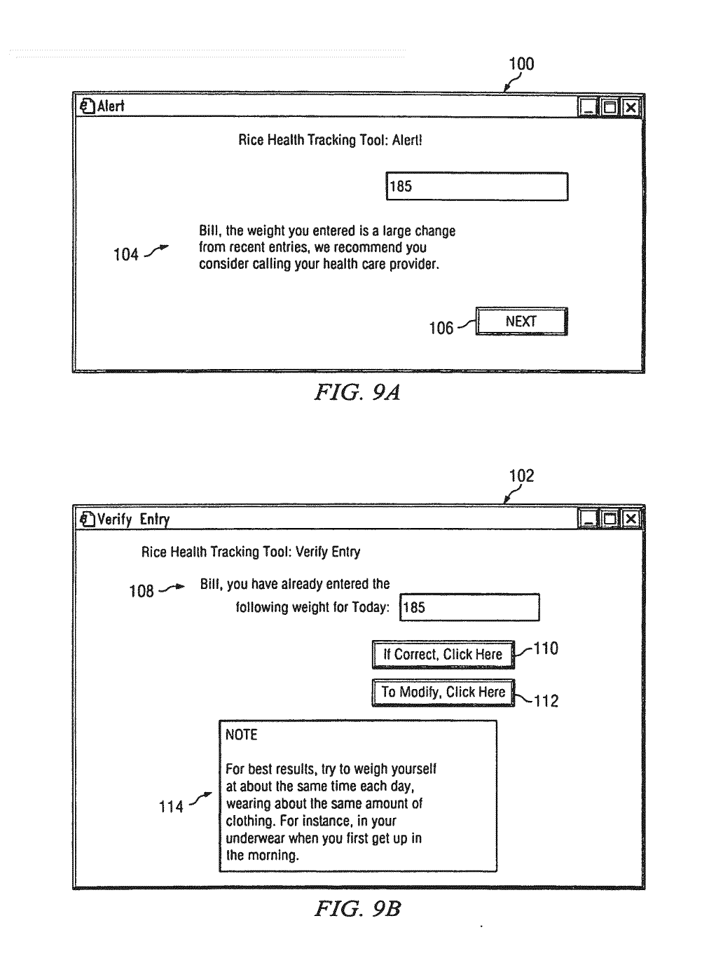

FIGS. 9A and 9B illustrate further exemplary screen shots 100 and 102, respectively. In FIG. 9A, the body weight entered of 185 exceeds a control range for the particular patient, causing the system to give the patient an “Alert” report 104, for example, with the words that “Bill, the weight you entered is a large change from recent entries, we recommend you consider calling your healthcare provider.” Next icon 106 allows the patient to progress to screen 102 of FIG. 9B.

Because the weight of 185 is entered after the initial entry of 125 on the same day, FIG. 9B shows a subsequent screen shot with a message 108 stating, for example, that “Bill, you have already entered the following weight for today.” Icons 110 and 112 permit, respectively, the patient to confirm that the entry is correct by clicking “If Correct, Click Here” or to modify by clicking “To Modify, Click Here.” A message 110 guides the patient with the statement that “For best results, try to weigh yourself at about the same time each day, wearing about the same amount of clothing. For instance, in your underwear when you first get up in the morning.” Other steps, as known to those skilled in the art, and messages may be taken to ensure the coherency and integrity of the data collection process.

A statistical analysis on the data collected through the above screens is performed using an averaging program and self-comparison of data. The system may use a control range established by the Deming statistical method, or other methodologies as known to those skilled in the art. In one example, when the weight of the patient exceeds about three percent of the control range, the system produces an Alert to the patient.

Statistical analyses steps for congestive heart failure may include establishing a base line weight associated with an initial stable condition for the patient. The system will then perform an analysis under consistent guidelines to establish weight data for future measurements. Then, the process will have the patient record his weight data and compare the data to baseline. This will permit a determination of a percentage weight change from the base line. In the preferred embodiment, if the percentage weight change represents a weight greater than a set percentage for the patient, an alert will be generated.

These control limits may be based on the individual and the population as a whole. For example, the system may 30 identify a trend of increasing weight for the individual or the fact that the individuals weight has exceeded an accepted value based on the individual's sex/height and age. Statistical analysis for other disease conditions can be approached in a similar manner. That is, with other diseases a baseline for one or more parameters may be set. Frequent subsequent data may then be collected from the patient relating to or containing measurements of the specific parameters. Statistical changes for parameters then may be established, based in part upon the character of the disease process and the particular details of the patient. The statistical changes that are used to analyze the patient will be dependent upon the disease, the volatility inherent in the data being measured, and other factors as known to those skilled in the art.

In FIG. 10, exemplary screen shot 120 presents a graphical report that the disclosed subject matter may provide. As discussed previously, the patient may choose to obtain a report by simply pressing “REPORTS” button 82. The report may track parameter(s) associated with the patient's clinical status. In the example shown, a graph of the measured body weight over a specified period of time is provided. The patient may choose the period of time reported, such as ten days, or thirty days, or another time interval.

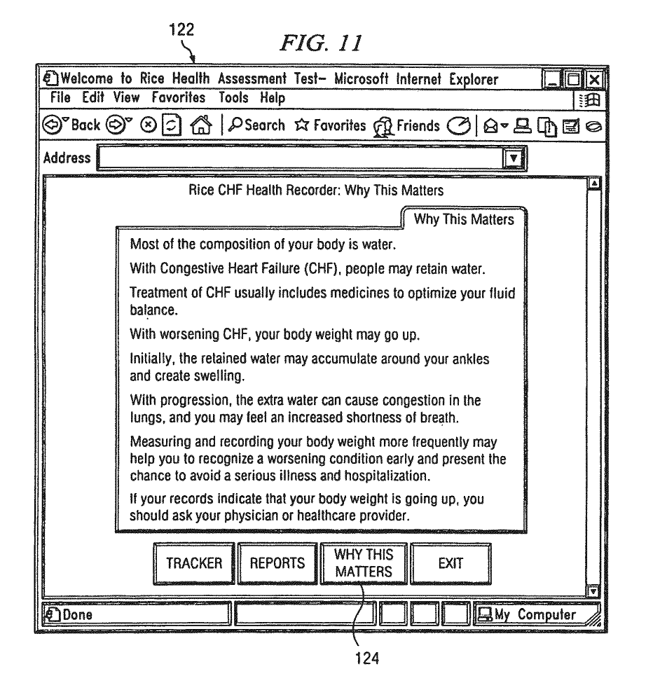

In FIG. 11, screen shot 122, explains the importance of tracking those parameter(s) to the patient. The patient may obtain more information on the significance of the tracking of the parameters by simply pressing “WHY THIS MATTERS” button 124. Exemplary screen shot 122 explains the importance of tracking weight in CHF patients and prompts the patient to call a physician or healthcare provider if the records indicate that his body weight is increasing. In another embodiment, the system may send an alert to the patient's healthcare team to initiate the process where the healthcare team then contacts the patient to schedule a physical examination.

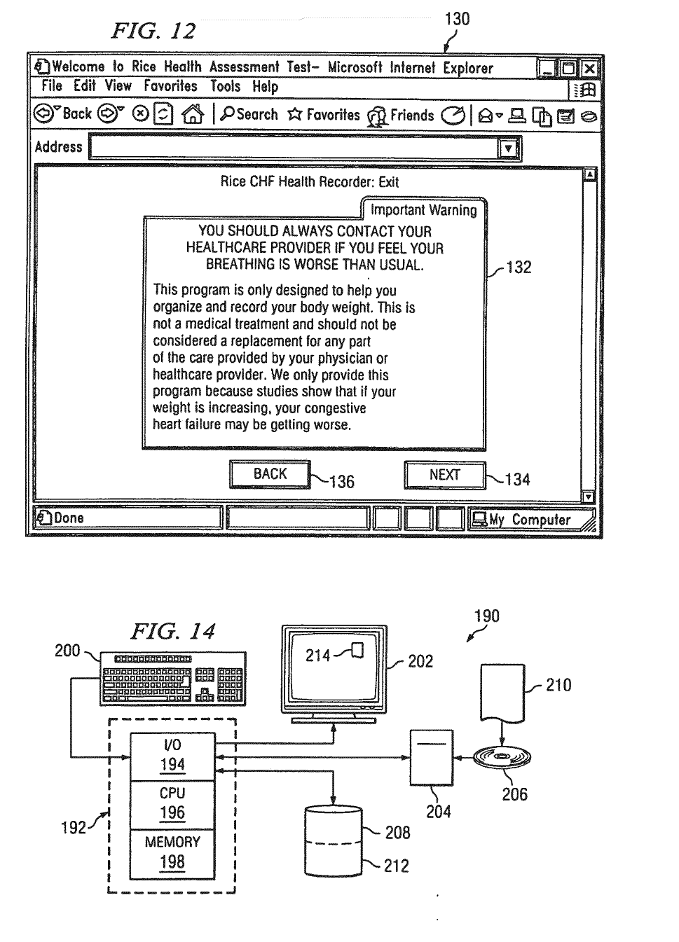

In FIG. 12, exemplary screen shot 130 appears when the patient desires to exit the system. Screen shot 130 provides a disclaimer or warning to the patient in window 132 that the program does not replace medical care. The patient then exits the system by clicking “EXIT” icon 134, or may return to system operations by clicking “BACK” icon 136.

In another embodiment, information is taken from a remotely located patient for statistical and medical analysis. The system then determines whether or not that information indicates a worsening medical condition that may require intervention by a healthcare professional. Instead of treating the medical condition from a remote location by using computers and the Internet with conventional schemes, the disclosed subject matter informs that patient and/or healthcare team of the fact that there may be cause for additional review of the patient. This intervention is based upon the results of statistical or medical analysis of one or more pre-selected parameters associated with a diagnosed condition. As a result of this notification, the system encourages, or may actually schedule, the patient to visit a physician or other health care professional, rather than attempting to avoid office visits. As a result, the patient may receive more prompt and, perhaps, more effective, less intensive medical attention.

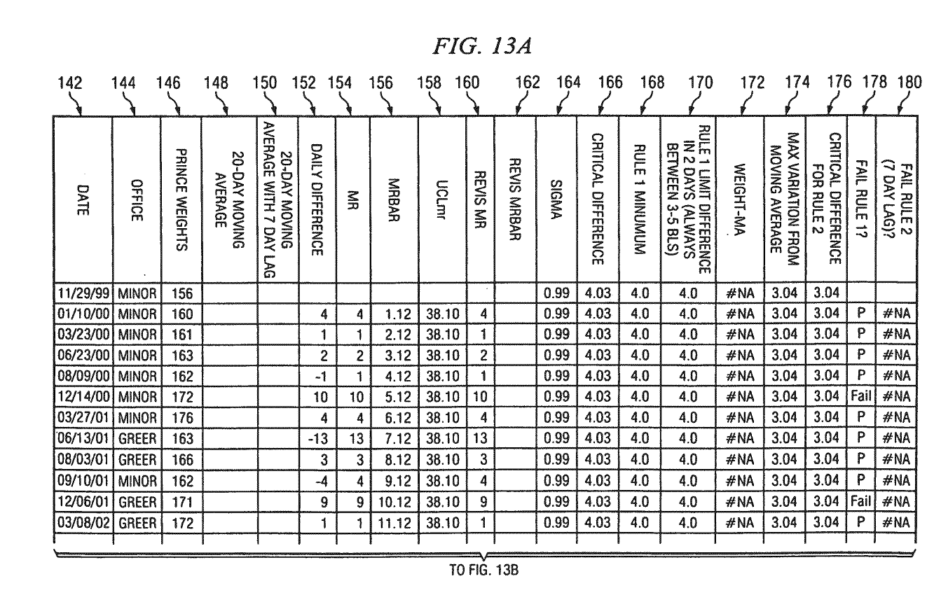

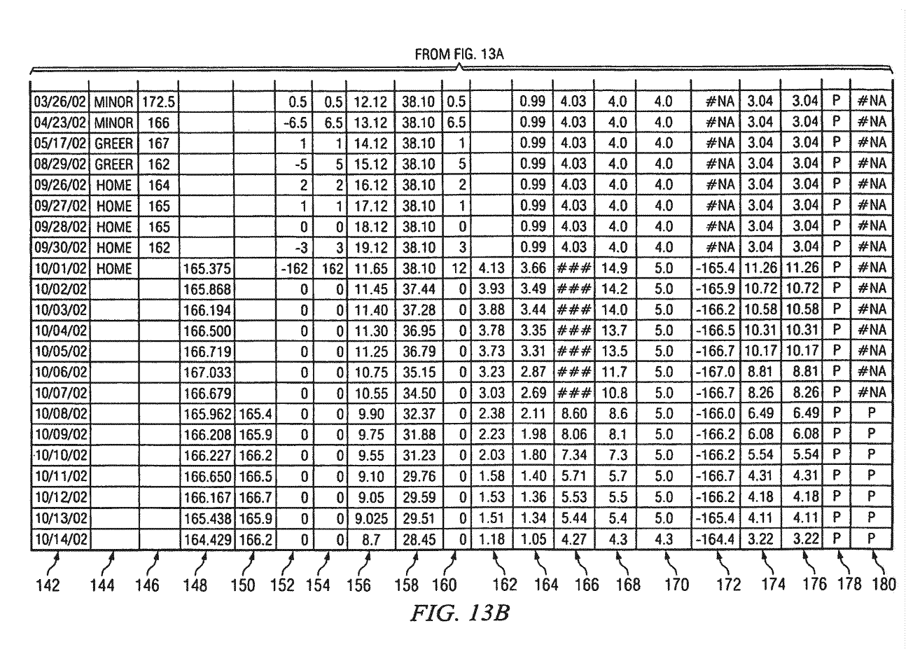

FIGS. 13 and 14 illustrate one embodiment of the statistical or medical analysis step 16 of FIG. 2 performed by the disclosed subject matter. Through the analysis of a patient's condition, the disclosed subject matter allows for a determination of whether a violation has occurred of one or more rules that would give rise to an early-stage alert condition, as stated with reference to step 18 of FIG. 2.

In essence, the calculations of the present embodiment may be understood with reference to spreadsheet 140, which shows two exemplary rules for which the present embodiment may test. Clearly, although the rules here stated relate to a CHF patient, similar or different rules could be established and tested consistent with the scope and purposes of this disclosure.

A first rule, then, for which spreadsheet 140 tests has to do with a patient's weight gain from one day to another. Rule 1 tests the deviation in daily weight against a minimum and a maximum weight gain. The minimum weight for which the system generates first alert is three pounds change in body weight. This amount may be based on such sources as the medical or scientific literature relating to the patient's condition. The maximum weight gain in this instance is five pounds, again, here based on the particular patient's condition and relevant scientific or medical literature. Rule 1 further calculates, using a value here called sigma. The value of sigma changes according to the patient's average weight over twenty consecutive measurements. From the sigma value a critical difference value of 2.88 times the square root of 2, which product is further multiplied by the relevant value of sigma value at the time of the patient weight measurement to yield a test value.

By initializing the below-described sigma at 0.98, an initial critical difference of 4.0 pounds over a one-day interval, for example, results. Thus, in the event of a weight change or 4.0 pounds, the disclosed subject matter will transmit an alert to the patient.

A second rule for which this instance of the present embodiment tests in deviations in daily weight is also based on a moving or rolling twenty-weight measurement set. Such a set of measurements may be obtained, for example, through twenty days of continual daily weight measurements. Under this second rule, the disclosed subject matter determines whether a minimum difference of two pounds is measured. No upper limit pertains to this second rule. The process derives a critical difference as a rolling average of twenty measurements, but here using a seven-measurement lag—and three times the moving sigma, based on twenty prior measurements, as specified in detail below.

For purposes of the present embodiment and in the case of CHF, the seven-measurement lag may represent, for 5 example, the set of twenty measurements where the most recent measurement occurred seven days ago and the least recent occurred twenty-seven days ago, with daily measurements occurring each of the intervening days.

In another embodiment, a different set of measurements might be more appropriate to take than the twenty measurements and seven-day lag used in the CHF case. Different diseases may develop acute exacerbations over varying amounts of time. It is important to exclude the timeframe of the evolving change from the baseline 15 measurements. For example, in diabetic ketoacidosis, the time of evolving symptoms might be three days. So, in that example, it would be best to exclude the past three days measurements from the baseline data. This would have the effect of assuring the most effective early warning. In other words, data arising during the evolution of the exacerbation will not contribute to an artificially elevating baseline. With more particular reference to spread sheet 140 of FIG. 13A-B and to further explain the application of the two rules mentioned above, notice that there appears. Information, including the date of a patient's weight measurement of column 142 and the location of which the weight measurement occurred of column 144. For the exemplary patient “Bill Price,” the weight measurements (e.g., 156 pounds taken at Dr. Minor's office on Nov. 29, 1999) appear on column 146. Column 148 shows the results of a rolling twenty-day average of patient Bill Price's weights (e.g., a weight of 165.375 calculated on Oct. 1, 2002). In Column 150 appears a further set of data which includes a rolling twenty-day average of patient Bill Price's weight, but measured with a twenty-day lag.

That is, the data represents for the current day that information for which the most recent of the twenty days occurs twenty days prior. A daily difference of measurements appears at column 152, followed by a scalar number, in column 154, representing the magnitude of the difference of the current day's measurement from the lagged twenty-day measurement from column 150. Column 156 calculates the average of up to the prior twenty-days measurements of the absolute value measurements appearing in column 154. The values for column 158 derive from the rules, and have the column title UCLmt, depicting a limit calculation based on the value of 3.27 times the MrBar value. Column 160 presents the number MR, as from column 154, but here revised according to comparison of if the MR value is greater than the UCLmt value, then the column 160 value is given as the MrBar value. Otherwise, the process uses the MR value for its further calculations. After twenty measurements, column 162 presents a further revised MrBar value, similar to that derived in column 156 and revised as the average of the past twenty values of Revised MR of column 160. These cumulative calculations derive the above-mentioned sigma value as the corresponding value of the Revised MR divided by 1.128, which column 164 contains. Then, based on the existing sigma value, the calculated value of the above-mentioned formula of 2.88 times the square root of 2 further multiplied by the sigma value of column 164 appears in column 166 as the critical value to be tested against. The rule one minimum appearing in column 168 is the greater of 3 or the critical difference value in column 166. Column 170 shows the determined value for weight according to the first rule limit. This value ranges from three to five pounds.

At column 172, a weight measurement moving average is taken for use in further calculations. Column 174 shows the results of a calculation for the moving average maximum variation from the moving average. In column 176 appears the critical difference calculation for the measurements against the rule two limits. The results of passing or failing the boundaries of rules one and two are shown in columns 178 and 180, respectively.

As should be clear from the above, the particular values for the rules and the number of rules may change depending on the particular chronic disease and the associated parameters for the disease for which early detection proves beneficial. Nonetheless, the clear import of the above description is that the disclosed subject matter, through a potentially wide variety of embodiments provides a system and method of modeling chronic disease using a non-linear model together with a set of optimization routines to reduce healthcare costs and improve quality at the same time.

For many chronic conditions, the worsening of a patient's health does not follow a predictive model, and standardized therapies based upon broad demographic models are not suitable. These conditions make it difficult to treat some types of chronic diseases remotely.

In general, certain parameters are associated with certain types of chronic diseases. For example, a patient's weight is generally associated with congestive heart failure, whereas peak flow is generally associated with asthma. Glucose is generally associated with diabetes, whereas mood and depression charts are generally associated with mental health problems.

In an embodiment, statistical models that have been applied to chaotic systems, such as to weather forecasting by NOAA, are applied to one or more selected parameters of the patient associated with a chronic disease to determine the probability of worsening medical condition of the patient. By alerting the patient or their healthcare providers of the potentially worsening medical condition, the condition may be diagnosed, treated and managed early on by a healthcare professional, thereby avoiding more catastrophic and costly medical intervention later where the potential outcomes are not as favorable.

As discussed previously relating to the volatility analysis of biometric data, traditional biometric data analysis relies on established maximum and minimum levels and compares current data points against those historic maximums and minimums. However, the disclosed type of volatility analysis can give medical professionals an additional method to evaluate the effectiveness of a treatment or an additional method to evaluate a potential change in a patient's condition. For example, if prior to starting a particular treatment the patient's data points were within the minimum and maximum ranges and after a treatment the patient's data points remained within the range, a medical professional could conclude the treatment was having no result in the patient.

However, if the medical professional were to analyze the volatility of the patient's data points, the medical professional may be able to come to a more accurate conclusion as to the effectiveness of the treatment. For example, if the patient's data points prior to treatment where highly volatile and after treatment were not very volatile, the medical professional could draw the conclusion that the treatment was in fact having a result in the patient. Thus, if the medical professional had only looked to the range of the absolute values (minimum and maximum levels) the medical professional may have come to an incorrect result.

Those with skill in the arts will recognize that the disclosed embodiments have relevance to a wide variety of areas in addition to those specific examples described below.

All references, including publications, patent applications, and patents, cited herein are hereby incorporated by reference to the same extent as if each reference were individually and specifically indicated to be incorporated by reference and were set forth in its entirety herein.

A technical advantage of the disclosed subject matter is it provides an additional analysis tool to medical professionals to evaluate a patient's response to a treatment

Another technical advantage of the disclosed subject matter is it provides an additional analysis tool to medical professionals to predict potential future problems.

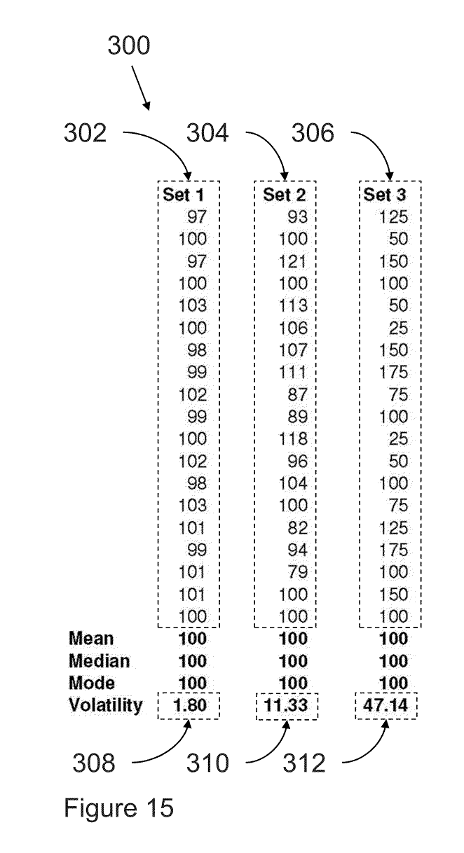

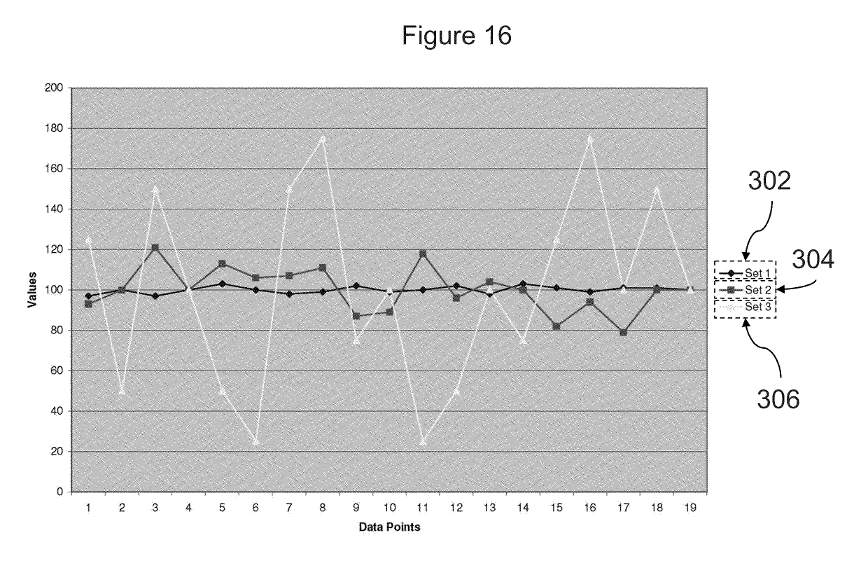

FIGS. 15 and 16 depict a table of three sets of data points and a graph of those three sets of data points, respectively. Looking first at FIG. 15, there is shown three data sets 300 made up of Set 1 302, Set 2 304, and Set 3 306. Each data set shown comprises several data points. These data points are contrived and intended only as an example.

Traditional statistical analysis could include mean, mode, and median. The mean is what is commonly referred to as an arithmetic average and is the sum of the data points divided by the number of the data points. Therefore, the median of 2, 4, 6, 6, and 7 is 5. The mode is the number which occurred most frequently. Therefore, the mode of 2, 4, 6, 6, and 7 is 6 because the 6 occurs twice and all the other numbers only occur once. The median is the number that would be the middle number if all numbers in a data set were arranged in either descending or ascending order. Therefore, the median of 2, 4, 6, 6, and 7 is 6 because it is the middle number.

Volatility on the other hand is a measure of the spread amongst the numbers within a data set. For example, a data set containing 5, 3, 2, 1, and 3 has less volatility than 5, 1, 5, 1, 5. Volatility can be calculated through a standard deviation calculation. The standard deviation measures statistical dispersion of a data set.

Returning to FIG. 15, Set 1 302, Set 2 304, and Set 3 306 all have a mean, median, and mode of 100. If a medical professional only looked at these numbers, the professional could conclude that the patient had little to no change over the period the data points were taken. However, upon a volatility analysis, the medical professional would notice that Set 1's Volatility 308 was 1.80, Set 2's Volatility 310 was 11.33, and Set 3's Volatility 312 was 47.14. By analyzing the data sets based on volatility, the medical professional could see there was actually drastic change between the data sets. FIG. 16 graphically depicts the volatility analysis. By looking at the graph, one can see that Set 2 304 is more volatile than Set 1 302 by looking at the extent of the swings in the data points. Likewise, Set 3 306 is more volatile than both Set 1 302 and Set 2 304.

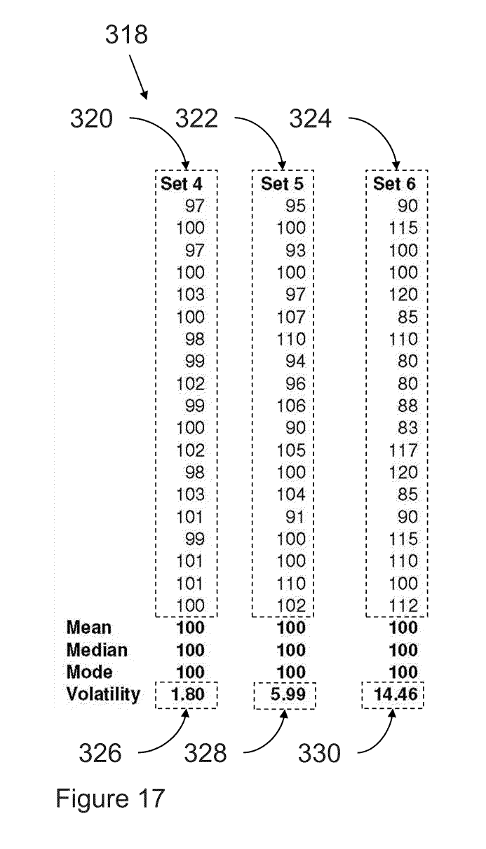

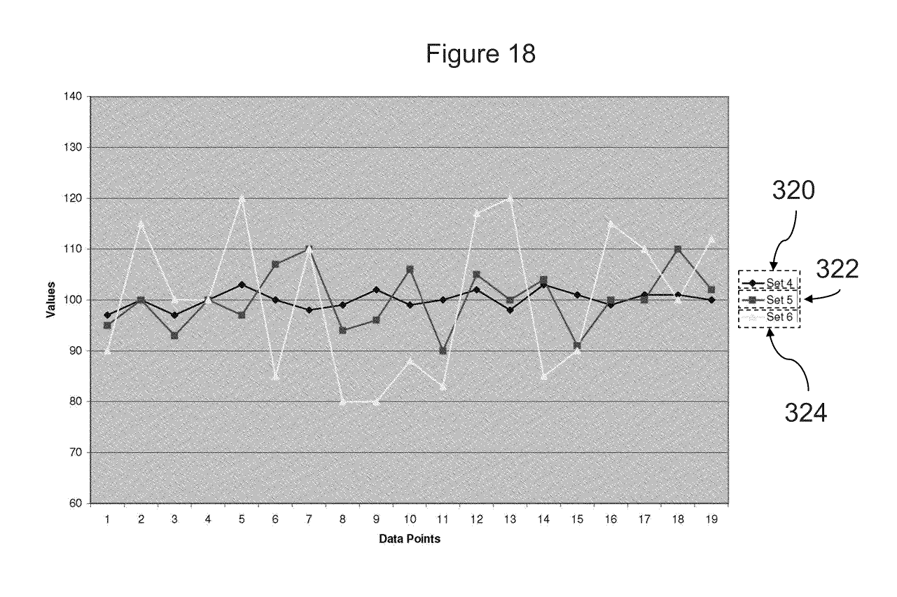

FIGS. 17 and 18 depict another table of three sets of data points and a graph of those three sets of data points respectively. Looking first at FIG. 17, there is shown three data sets 318 made up of Set 4 320, Set 5 322, and Set 6 324. Each set 318 has several data points. These data points are contrived and intended only as an example.

Referring to FIG. 17, the mean, mode, and median all are 100 for all of the data sets 318. In addition to this type of statistical analysis, most traditional analysis compares data points to a prescribed range. For example, if the prescribed “normal” range was between 80 and 120, then Set 4 320, Set 5 322, and Set 6 324 are all within the normal range. Again, a medical professional could conclude that the patient was stable and that no further analysis was necessary. However, by conducting a volatility analysis, the medical professional could notice that there is a pattern of increasing volatility within the data sets starting with Set 4 320 and increasing through Set 6 324. A large change in volatility could be indicative of a future potential problem. By analyzing the volatility, the medical professional could alter the patient's treatment (or begin treatment) in order to address the change in volatility.

Though discussed with particular emphasis to standard deviation, this disclosure is intended to include other forms of volatility analysis known to those with skill in the art and these forms are within the scope of the term volatility. Further, certain volatility ranges may be associated with particular medical conditions or patients.

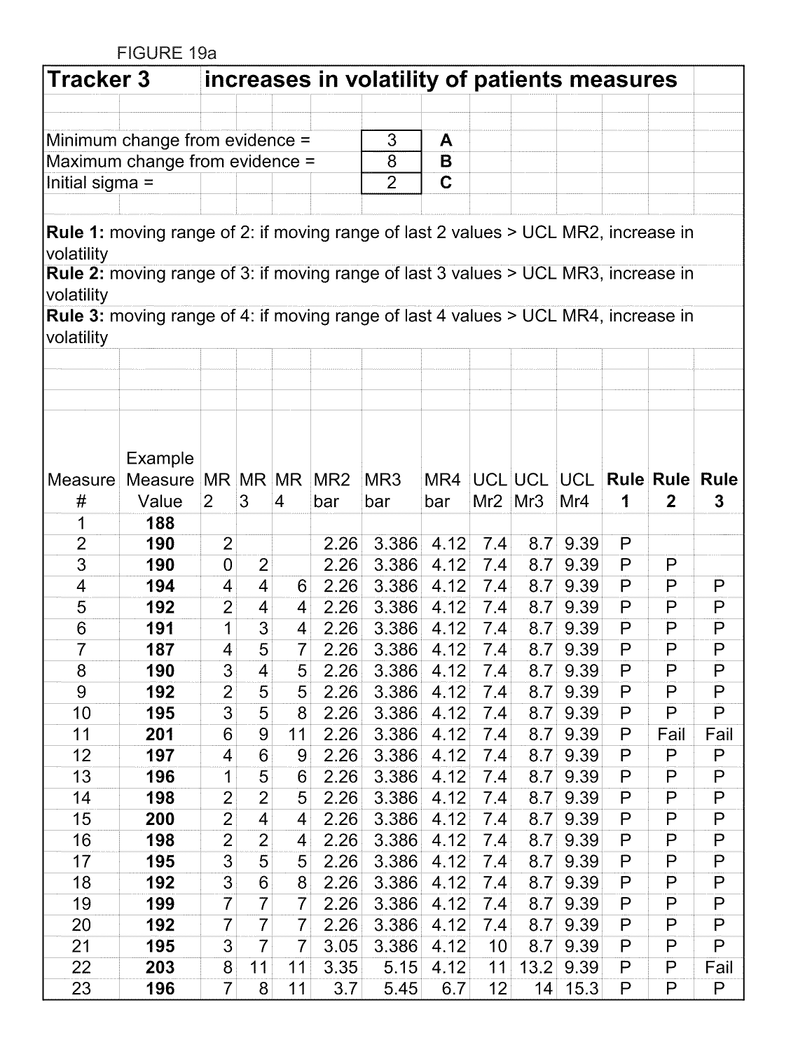

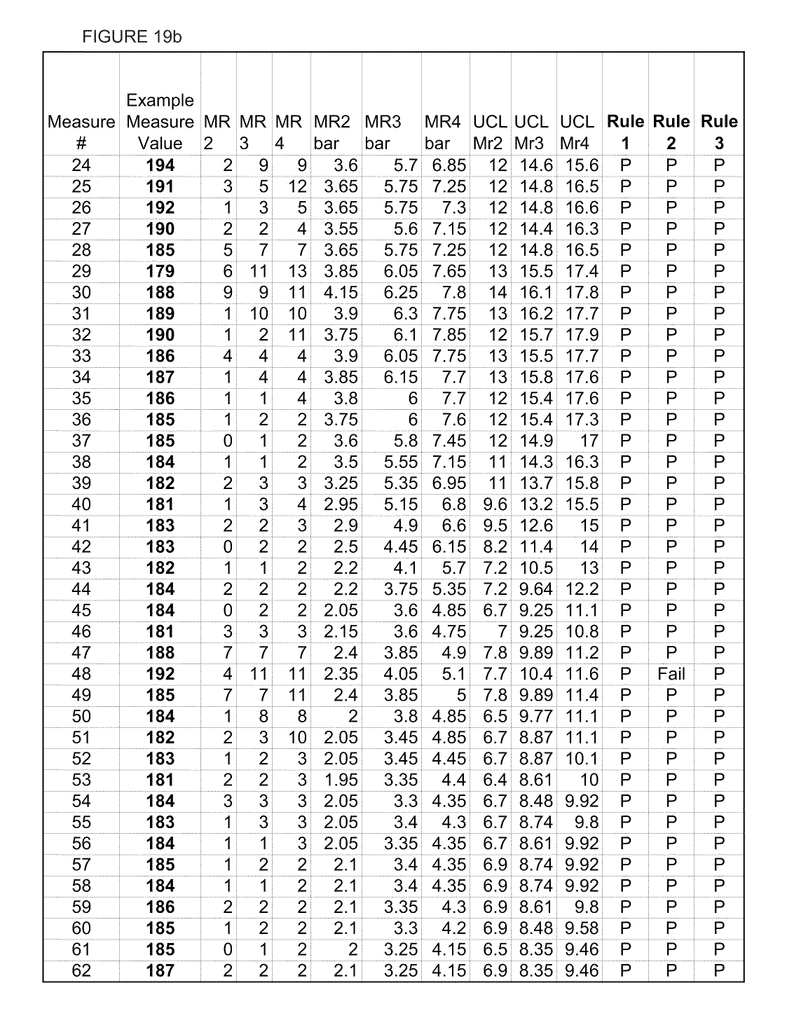

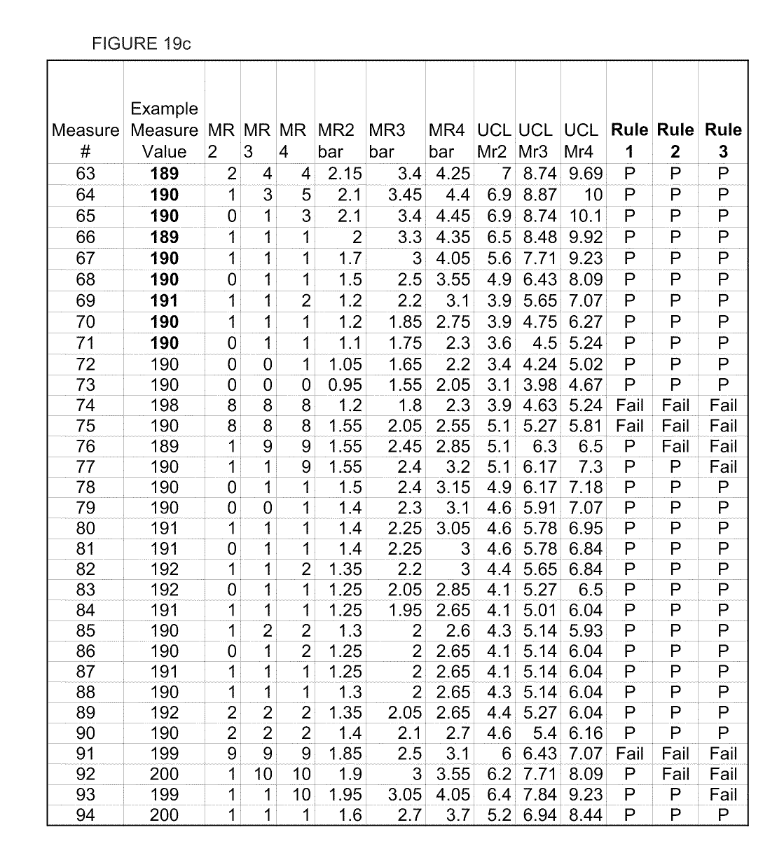

In essence, the calculations of the present embodiment may be understood with reference to the spreadsheet depicted in FIGS. 19A-C. The Example Measure Values provide data for the volatility analysis shown. MR2 provides the moving range (MR) of 2 data points, for example MR2 for Measure 5 is =ABS(Measure 4−Measure 5)=Absolute value of (194−192)=2. For explanatory purposes, continuing with Measure 5, MR3 provides the moving range of 3, so MR3=Max(Measures 3 thru 5)−Min(Measures 3 thru 5)=Max(190,194,192)−Min(190,194,192)=4. For explanatory purposes, continuing with Measure 5, MR4 provides the moving range of 4, so MR4=Max(Measures 2 thru 5)−Min(Measures 2 thru 5)=Max(190,190,194,192)−Min(190,190,194,192)=4. Shown, in applying Rule 1, 2, or 3, and as shown in the Rule 1, Rule 2, and Rule 3 columns, “Fail” indicates an increase in volatility—and thus acts as an alert—and “P” indicates the alternative—no increase in volatility.

The methods and apparatus of the disclosed subject matter, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the disclosed subject matter. The methods and apparatus of this disclosure may also embody the form of program code transmitted over some transmission medium, such as over electrical wiring or cabling, through fiber optics, or via any other form of transmission, as known to those skilled in the art, wherein, when the program code is received and loaded into and executed by a machine such as a computer, the machine becomes an apparatus for practicing the disclosed subject matter. When implemented on a general-purpose processor, the program code combines with the processor to provide a unique apparatus that operates analogously to specific logic circuits.

FIG. 14 illustrates a typical computer system including traditional components of a personal computer. The disclosed subject matter can have components similar to those shown, and furthermore, through accessing the Internet, the system may interact and interface with components on larger computers similar to examples illustrated in FIG. 14.

A general-purpose workstation computer 190 comprises a processor 192 having an input/output (“I/O”) section 194, a central processing unit (“CPU”) 196 and a memory section 198 (including a digital database). The I/O section 194 is coupled to keyboard 200, display unit 202, which shows visual output 214, disk storage unit 208, 212 and CD-ROM drive unit 204. The CD unit 204 can read CD-ROM medium 206 that typically contains programs 212 and data 208. The disk storage unit can be, or is connected to, a digital database or network server 210. The connection can be via a modem or other digital communication devices, such as wireless receiver and transmission components as used in PDAs and wireless communication devices known to one of ordinary skill in the art. The database server and network server 210 can be the same device or two separate but coupled devices.

Computer 190 may be a network appliance, personal computer, desktop computer, laptop computer, top box, web access device, or any like device. Use of computers also contemplates other devices similar to or incorporating computers, such as personal computers, television interfaces, kiosks, and the like.

Embodiments of this disclosure may be implemented in a standalone system, entirely on the patient's computer hard drive so that there are no privacy or security concerns. The method according to embodiments of this disclosure does not necessarily need a computer at all. A person may use a telephone, a personal digital assistant (PDA), or other means to record the data measurements described above. The patient also could be alerted by telephone, or such other means.

The present disclosure provides a computer-implemented method and system for identifying volatility in medical data of a patient, including the analysis and reporting of statistical information regarding a patient's diagnosis and/or response to treatment in order to reduce healthcare costs and improve patient quality of life. Alerts may be providing indicating an increase or decrease in volatility outside a range, or a data point of note or potentially anomalous data point has been received. To accomplish this, one or more sets of medical data are evaluated to determine the data's volatility. In one embodiment, the volatility analysis may then be compared to another data set to provide insight into a diagnosis or a patient's response to treatment. The biometric data may include, but is not limited to: body weight, peak flow, glucose, number of nitroglycerin tablets taken, number of chest pain episodes, minutes walking without pain, ambulation distance without pain, number of emesis, number of episodes of diarrhea, mood charts, depression charts, and food/liquid intake.

The data may either be automatically entered or manually entered into the computer system shown in FIG. 5 or received from a data source. The disclosed subject matter may be implemented by a computer program executed within a computer, such as a personal computer, personal data assistant, network appliance, web access device, computer kiosks, television interfaces or like device. The program may comprise instructions that enable to processor to perform the tasks of: (1) collecting and evaluating the volatility of the biometric data; (2) performing a volatility analysis to evaluate a patient's response to a treatment or predict future problems; and (3) alerting the patient or health care provider to those analyses which indicate a potentially anomalous or critical volatility within the data.

In one embodiment, a computer performs the process of collecting data, processing, and providing alerts. Similarly, other information transactions can be accomplished on various wireless and PDA-type devices.

In operation, the disclosed subject matter provides a method and system for identifying volatility in medical data including the analysis and reporting of statistical information regarding a patient's diagnoses and/or response to treatment is disclosed. One or more sets of medical data is evaluated to determine the data's volatility. The volatility analysis may then be compared to another data set to provide insight into a diagnoses or a patient's response to treatment.

Those skilled in the art may readily devise additional embodiments from the features and functions described herein. Various modifications to these embodiments will be readily apparent to those skilled in the art, and the principles defined herein may be applied to other embodiments without the use of the innovative faculty. Thus, the subject matter is not intended to be limited to the embodiments shown herein, but is to be accorded the widest scope consistent with the principles and novel features disclosed herein.

What is claimed is:

1. A method for evaluating the effectiveness of a medical treatment and predicting future medical issues, comprising:
receiving a digital set of biometric data comprising a plurality of biometric data points and storing said set of biometric data in a digital database;
analyzing said digital set of biometric data to determine the relative volatility of said set of biometric data points; and
evaluating said relative volatility.

2. The method of claim 1, wherein said step of evaluating said relative volatility further comprises comparing said relative volatility of said set of biometric data to the relative volatility of another set of biometric data.

3. The method of claim 1, wherein said step of evaluating said relative volatility further comprises evaluating said relative volatility against a predetermined range specific to said set of biometric data.

4. The method of claim 1, further comprising inputting a new data point into said set of biometric data and determining whether said new data point increases or decreases said relative volatility.

5. The method of claim 1, further comprising providing an alert when said relative volatility is anomalous based on predetermined criteria.

6. The method of claim 1, further comprising providing an alert when said relative volatility is anomalous based on predetermined criteria or a patient's previous baseline, where the measure of increased volatility is a signal of a worsening clinical state.

7. The method of claim 1, further comprising providing an alert when said relative volatility is anomalous based on predetermined criteria or a patient's previous baseline, where the measure of decreased volatility is a signal of a worsening clinical state.

8. The method of claim 1, further comprising inputting a plurality of new data points into said set of biometric data, determining the relative volatility of said set of biometric data after each new data point has been input into said set of biometric data, and providing an alert when said relative volatility is anomalous.

9. A system for evaluating the effectiveness of a medical treatment and predicting future medical issues, comprising:
a digital database for receiving and storing a digital set of biometric data comprising a plurality of biometric data points; and
a processor comprising instructions operable to analyze said digital set of biometric data to determine the relative volatility of said set of biometric data points and evaluate said relative volatility.

10. The system of claim 9, wherein said processor further comprises instructions to compare said relative volatility of said set of biometric data to the relative volatility of another set of biometric data.

11. The system of claim 9, wherein said processor further comprises instructions to evaluate said relative volatility against a predetermined range specific to said set of biometric data.

12. The system of claim 9, wherein said processor further comprises instructions to determining whether each data point increases or decreases said relative volatility.

13. The system of claim 9, wherein said processor further comprises instructions to provide an alert when said relative volatility is anomalous based on predetermined criteria.

14. The system of claim 9, wherein said processor further comprises instructions to determine the relative volatility of said set of biometric data after each data point has been input into said set of biometric data and provide an alert when said relative volatility is anomalous.

15. The system of claim 9, wherein said processor further comprises instructions to provide an alert when said relative volatility is anomalous based on predetermined criteria or a patient's previous baseline, where the measure of increased volatility is a signal of a worsening clinical state.

16. The system of claim 9, wherein said processor further comprises instructions to provide an alert when said relative volatility is anomalous based on predetermined criteria or a patient's previous baseline, where the measure of decreased volatility is a signal of a worsening clinical state.
